(19) United States
(12) Patent Application Publication
(10) Pub. No.: US 2025/0324976 A1
(43) Pub. Date: Oct. 23, 2025

(54) METHOD AND COMPOSITION OF SYNERGISTIC HERBICIDAL MIXTURES

(71) Applicant: PRO FARM GROUP, INC., Davis, CA (US)

(72) Inventors: Matthew Louis Robinson, West Sacramento, CA (US); Louis Gregory Boddy, Woodland, CA (US)

(21) Appl. No.: 18/860,624

(22) PCT Filed: Apr. 28, 2023
(86) PCT No.: PCT/US2023/020372

§ 371 Date: Oct. 25, 2024

Related U.S. Application Data
(60) Provisional application No. 63/336,027, filed on Apr. 28, 2022.

(51) Int. Cl. A01N 63/20; A01N 43/90; A01P 13/00; A01P 17/00

(52) U.S. Cl. CPC A01N 63/20; A01N 43/90; A01P 13/00; A01P 17/00

(57) ABSTRACT

The present invention provides a method of use and a synergistic herbicidal composition comprising: (a) the compound spliceostatin C; (b) an effective amount of one or more plant nutrients; and (c) at least one of a carrier, diluent, surfactant, adjuvant, wherein the composition inhibits growth of said weed.

### PRIORITY

This application claims priority to U.S. provisional application No. 63/336,027, filed Apr. 28, 2022.

### TECHNICAL FIELD OF THE INVENTION

The present disclosure generally relates to a composition and method of use of selected plant micronutrients for enhancing the herbicidal effectiveness of FR901464 and/or spliceostatin

C. More particularly, it relates to methods, compositions, and metabolites for controlling and inhibiting emergence and/or growth of monocotyledonous, sedge or dicotyledonous weeds.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Natural products are substances produced by microbes, plants, and other organisms. Microbial natural products offer an abundant source of chemical diversity, and there is a long history of utilizing natural products for pharmaceutical purposes. A few of such compounds are FR901464 and spliceostatin C, which have been found to be useful as an antibacterial agent and antitumor agent. These compounds are ultrapotent inhibitors of eukaryotic RNA splicing, via binding to the SF3b subunit of the U2 snRNA subcomplex, an essential component of the spliceosome.

### SUMMARY OF THE INVENTION

The present invention provides a method for inhibiting emergence or growth of monocotyledonous, sedge or dicotyledonous weeds comprising: applying a composition of: a) an effective amount of a compound having the general formula, Formula I:

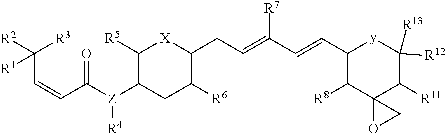

wherein X, Y and Z are each independently —O, —NR, or —S, wherein R is H or C1-C10 alkyl; R1, R2, R3, R4, R5, R6, R7, R8, R11, R12, and R13 are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl; b) an effective amount of one or more plant micronutrients; and c) at least one of a carrier, diluent, surfactant, adjuvant, wherein the composition inhibits growth of said weeds.

The compound may be spliceostatin C or FR901464. The effective amount of one or more plant nutrients (micro and/or macro nutrients) may be iron, zinc, boron, chlorine, copper, molybdenum, nickel, phosphate and potassium. The monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, Cyperus difformis, and Lactuca sativa. The composition further comprises an additional herbicidal compound or pesticide compound. The additional herbicidal compound comprise clove, cinnamon, lemongrass, citrus oils, orange peel oil, tentoxin, cornexistin, AAL-toxin, leptospermone, thaxtomin, sarmentine, momilactone B, sorgoleone, ascaulatoxin and ascaulatoxin aglycone. The chemical herbicide can include, but is not limited to, diflufenzopyr and salts thereof, dicamba and salts thereof, topramezone, tembotrione, S-metolachlor, atrazine, mesotrione, primisulfuron-methyl, 2,4-dichlorophenoxyacetic acid, nicosulfuron, thifensulfuron-methyl, asulam, metribuzin, diclofop-methyl, fluazifop, fenoxaprop-p-ethyl, asulam, oxyfluorfen, rimsulfuron, mecoprop, and quinclorac, thiobencarb, clomazone, cyhalofop, propanil, bensulfuron-methyl, penoxsulam, triclopyr, imazethapyr, halosulfuron-methyl, pendimethalin, bispyribac-sodium, carfentrazone ethyl, sodium bentazon/sodium acifluorfen, glyphosate, glufosinate, stearyl alcohol, or orthosulfamuron. The compound is isolated from Burkholderia sp. The Burkholderia sp. may be Burkholderia A396 (NRRL B-50319). The composition further comprises a salt or stereoisomer thereof.

The present invention provides a method for inhibiting emergence or growth of monocotyledonous, sedge or dicotyledonous weeds comprising: applying to said plant, plant part, or substrate used to grow said plant, an effective amount of a fermented composition comprising whole cell broth collected from Burkholderia A396 (NRRL Accession No. B-50319) fermentation and an effective amount of one or more plant micronutrients. The whole cell broth comprises spliceostatin C or FR901464. The whole cell broth comprises an effective amount of a compound having the general formula:

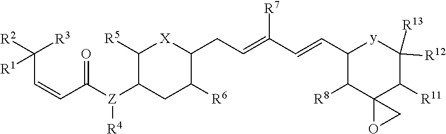

wherein X, Y and Z are each independently —O, —NR, or —S, wherein R is H or C1-C10 alkyl; R1, R2, R3, R4, R5, R6, R7, R8, R11, R12, and R13 are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl. The effective amount of one or more plant nutrients comprise iron, zinc, boron, chlorine, copper, molybdenum, nickel, phosphate and potassium. The monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and Lactuca sativa. The whole cell broth further comprises an additional herbicidal compound or pesticide compound. The additional herbicidal compound comprises clove, cinnamon, lemongrass, citrus oils, orange peel oil, tentoxin, cornexistin, AAL-toxin, leptospermone, thaxtomin, sarmentine, momilactone B, sorgoleone, ascaulatoxin and ascaulatoxin aglycone. According to another aspect, the additional herbicidal compound comprises diflufenzopyr and salts thereof, dicamba and salts thereof, topramezone, tembotrione, S-metolachlor, atrazine, mesotrione, primisulfuron-methyl, 2,4-dichlorophenoxyacetic acid, nicosulfuron, thifensulfuron-methyl, asulam, metribuzin, diclofop-methyl, fluazifop, fenoxaprop-p-ethyl, asulam, oxyfluorfen, rimsulfuron, mecoprop, and quinclorac, thiobencarb, clomazone, cyhalofop, propanil, bensulfuron-methyl, penoxsulam, triclopyr, imazethapyr, halosulfuron-methyl, pendimethalin, bispyribac-sodium, carfentrazone ethyl, sodium bentazon/sodium acifluorfen, glyphosate, glufosinate, stearyl alcohol, or orthosulfamuron.

The present invention provides a synergistic herbicidal composition comprising: (a) the compound FR901464 or spliceostatin C; b) an effective amount of one or more plant micronutrients; and c) at least one of a carrier, diluent, surfactant, adjuvant, wherein the composition inhibits growth of said weeds. The compound may be spliceostatin C or FR901464. The effective amount of one or more plant nutrients (micro and/or macro nutrients) comprise iron, zinc, boron, chlorine, copper, molybdenum, nickel, phosphate and potassium. The monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and Lactuca sativa. In some examples, the composition further comprises an additional herbicidal compound or pesticide compound.

The present invention provides a synergistic herbicidal composition comprising: (a) the compound having the general formula:

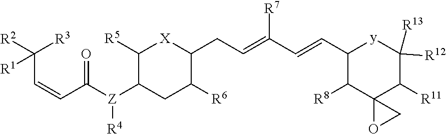

wherein X, Y and Z are each independently —O, —NR, or —S, wherein R is H or C1-C10 alkyl; R1, R2, R3, R4, R5, R6, R7, R8, R11, R12, and R13 are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl; (b) an effective amount of one or more plant micronutrients; and (c) at least one of a carrier, diluent, surfactant, adjuvant, wherein the composition inhibits growth of said weeds. The compound is spliceostatin C or FR901464. The effective amount of one or more plant micronutrients comprises an effective amount of one or more of: iron, zinc, boron, chlorine, copper, molybdenum, nickel; the effective amount of one or more plant macronutrients comprise an effective amount of one or more of phosphate and potassium. The monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and Lactuca sativa. The composition further comprises an additional herbicidal compound or pesticide compound.

### BRIEF DESCRIPTION OF THE DRAWINGS

For a more complete understanding of the features and advantages of the present invention, reference is now made to the detailed description of the invention along with the accompanying FIGURES and in which:

FIG. 1 is a plot of phytotoxicity of MBI-015 and fertilizers at rates of 0.5 or 1 μg/mL. Different letters represent significantly different groups using Tukey HSD. Bars represent standard error.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The compositions in the instant disclosure include naturally occurring compositions that have been isolated and purified. However the present disclosure also includes synthetic versions of those compositions and may include modifications and substitutions to the compositions.

As used herein the term “plant micronutrients” includes iron and zinc. Additional plant micronutrients include boron, chlorine, copper, molybdenum, and nickel.

Deposit of Biological Material. The following biological material has been deposited under the terms of the Budapest Treaty with the Agricultural Research Culture Collection (NRRL), 1815 N. University Street, Peoria, Ill. 61604 USA, and given the following number:
Deposit Accession Number Date of Deposit
Burkholderia sp. A396 (NRRL B-50319) Sep. 15, 2009

The strain has been deposited under conditions that assure that access to the culture will be available during the pendency of this patent application to one determined by the Commissioner of Patents and Trademarks to be entitled thereto under 37 C.F.R. § 1.14 and 35 U.S.C. § 122. The deposit represents a substantially pure culture of the deposited strain. The deposit is available as required by foreign patent laws in countries wherein counterparts of the subject application, or its progeny are filed. However, the availability of a deposit does not constitute a license to practice the subject invention in derogation of patent rights granted by government action.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process, or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed, provided that these additional materials, steps, features, components, or elements do not materially affect the basic and novel characteristic(s) of the recited subject matter. The term “consisting essentially of” occupies a middle ground between “comprising” and “consisting of”.

The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example: killing, retardation, leaf burn, albinism, dwarfing and the like.

The term “plants” refers to all physical parts of a plant, including seeds, seedlings, saplings, roots, tubers, stems, stalks, foliage, and fruits. The term “weeds” as used herein means any undesired plant, and thus includes not only agronomically important weeds as described below, but also volunteer crop plants.

As referred to herein, the term “seedling”, used either alone or in a combination of words means a young plant developing from the embryo of a seed.

The term “pre-emergence application” means application to the soil in which the weed seeds or seedlings are present before emergence of the weeds above the surface of the soil. The term “post-emergence application” means application to the aerial or exposed portions of the weeds which have emerged above the surface of the soil. The term “early post-emergence application” means application to the aerial or exposed portions of the weeds which have emerged above the surface of the soil and are between the cotyledonous stage and the second to third leaf stage (or third and fourth whole stage) of growth.

As defined herein, “whole broth culture” or “whole cell broth” refers to a liquid culture containing both cells and media. If bacteria are grown on a plate, the cells can be harvested in water or other liquid, whole culture. The terms “whole broth culture” and “whole cell broth” are used interchangeably.

As defined herein, “supernatant” refers to the liquid remaining when cells are grown in broth or are harvested in another liquid from an agar plate and are removed by centrifugation, filtration, sedimentation, or other means well known in the art.

As defined herein, “filtrate” refers to liquid from a whole broth culture that has passed through a membrane.

As defined herein, “extract” refers to liquid substance removed from cells by a solvent (water, detergent, buffer, organic solvent) and separated from the cells by centrifugation, filtration or other method.

As defined herein, “metabolite” refers to a compound, substance or byproduct of a fermentation of a microorganism, or supernatant, filtrate, or extract obtained from a microorganism that has herbicidal activity.

As defined herein, “derived from” means directly isolated or obtained from a particular source or alternatively having identifying characteristics of a substance or organism isolated or obtained from a particular source.

As defined herein, an “isolated or isolated compound” is essentially free of other compounds or substances, e.g., at least about 20% pure, preferably at least about 40% pure, more preferably about 60% pure, even more preferably about 80% pure, most preferably about 90% pure, and even most preferably about 95% pure, as determined by analytical methods, including but not limited to chromatographic methods, electrophoretic methods.

As used herein, the term “alkyl” refers to a monovalent straight or branched chain hydrocarbon group having from one to about 12 carbon atoms, including methyl, ethyl, n-propyl, isopropyl, n-butyl, isobutyl, tert-butyl, n-hexyl, and the like.

As used herein, “substituted alkyl” refers to alkyl groups further bearing one or more substituents selected from hydroxy, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, cyano, nitro, amino, amido, —C(O)H, acyl, oxyacyl, carboxyl, sulfonyl, sulfonamide, sulfuryl, and the like.

As used herein, “alkenyl” refers to straight or branched chain hydrocarbyl groups having one or more carbon-carbon double bonds, and having in the range of about 2 up to 12 carbon atoms, and “substituted alkenyl” refers to alkenyl groups further bearing one or more substituents as set forth above.

As used herein, “alkynyl” refers to straight or branched chain hydrocarbyl groups having at least one carbon-carbon triple bond, and having in the range of about 2 up to 12 carbon atoms, and “substituted alkynyl” refers to alkynyl groups further bearing one or more substituents as set forth above.

As used herein, “aryl” refers to aromatic groups having in the range of 6 up to 14 carbon atoms and “substituted aryl” refers to aryl groups further bearing one or more substituents as set forth above.

As used herein, “heteroaryl” refers to aromatic rings containing one or more heteroatoms (e.g., N, O, S, or the like) as part of the ring structure, and having in the range of 3 up to 14 carbon atoms and “substituted heteroaryl” refers to heteroaryl groups further bearing one or more substituents as set forth above.

As used herein, “alkoxy” refers to the moiety —O-alkyl-, wherein alkyl is as defined above, and “substituted alkoxy” refers to alkoxyl groups further bearing one or more substituents as set forth above.

As used herein, “thioalkyl” refers to the moiety —S-alkyl-, wherein alkyl is as defined above, and “substituted thioalkyl” refers to thioalkyl groups further bearing one or more substituents as set forth above.

As used herein, “cycloalkyl” refers to ring-containing alkyl groups containing in the range of about 3 up to 8 carbon atoms, and “substituted cycloalkyl” refers to cycloalkyl groups further bearing one or more substituents as set forth above.

As used herein, “heterocyclic”, refers to cyclic (i.e., ring-containing) groups containing one or more heteroatoms (e.g., N, O, S, or the like) as part of the ring structure, and having in the range of 3 up to 14 carbon atoms and “substituted heterocyclic” refers to heterocyclic groups further bearing one or more substituent's as set forth above.

As used herein, “Herbicide safeners” are substances added to a herbicide formulation to eliminate or reduce phytotoxic effects of the herbicide to certain crops. These compounds protect crops from injury by herbicides but typically do not prevent the herbicide from controlling undesired vegetation. Examples of herbicide safeners include but are not limited to benoxacor, cloquintocet-mexyl, cumyluron, cyometrinil, cyprosulfamide, daimuron, dichlormid, dicyclonon, dietholate, dimepiperate, fenchlorazole-ethyl, fenclorim, flurazole, fluxofenim, furilazole, isoxadifen-ethyl, mefenpyr-diethyl, mephenate, methoxyphenone, naphthalic anhydride, oxabetrinil, N-(aminocarbonyl)-2-methylbenzenesulfonamide and N-(aminocarbonyl)-2-fluorobenzenesulfonamide, 1-bromo-4-[(chloromethyl)sulfonyl]benzene, 2-(dichloromethyl)-2-methyl-1,3-dioxolane (MG 191), 4-(dichloroacetyl)-1-oxa-4-azospiro-[4.5]decane (MON 4660), 2,2-dichloro-1-(2,2,5-trimethyl-3-oxazolidinyl)-ethanone and 2-methoxy-N-[[4-[[(methylamino)carbonyl]amino]phenyl]sulfonyl]-benzamide. Of note is dietholate, 2,2-dichloro-1-(2,2,5-trimethyl-3-oxazolidinyl)-ethanone and 2-methoxy-N-[[4-[[(methylamino)carbonyl]amino]phenyl]sulfonyl]-benzamide (alternatively named N-(2-methoxybenzoyl)-4-[(methylaminocarbonyl)amino]benzenesulfonamide; CAS #129531-12-0). Of particular note is 2-methoxy-N-[[4-[[(methylamino)carbonyl]amino]phenyl]sulfonyl]-benzamide (alternatively named N-(2-methoxybenzoyl)-4-[(methylaminocarbonyl)amino]benzenesulfonamide; CAS #129531-12-0).

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range.

Bacteria Fermentation. Chromobacterium violaceum WB968 or Burkholderia A396 are bacteria known in the art to produce secondary metabolites with herbicidal properties. For fermentation, typically, the carbon source in the culture medium can be any carbohydrate. In certain embodiments, the carbon source is a monosaccharide or disaccharide (e.g., glucose). In certain particular embodiments, the carbon source is glucose or maltodextrin. Other carbohydrates such as starch, maltose, sucrose, fructose, or glycerin may be used in certain embodiments. In certain embodiments, the source of some or all of the carbon can also be an amino acid or complex nutrient that provides carbon and some or all of the nitrogen. In certain embodiments, the nitrogen source is ammonia or an ammonium salt such as ammonium sulfate, ammonium nitrate, ammonium phosphate, etc. In other embodiments, nitrogen and some or all of the carbon come from plant peptone (e.g., polypeptone NS, corn steep liquor, Hinute R). Other complex sources of nitrogen and carbon that may be used include bouillon, yeast extract, soy peptone, gluten meal, cotton seed flour, soybean meal, dried yeast, and wheat germ. In certain embodiments, the nitrogen source is urea or amino acids. In certain embodiments, the nitrogen source is an organic small molecule containing nitrogen. In certain embodiments, the medium is supplemented with amino acids. For example, the medium may be supplemented with L-arginine, L-histidine, or L-cysteine. In certain embodiments, the medium is supplemented with L-cysteine. See WO 02/20817; incorporated herein by reference in its entirety. In certain embodiments, the medium is supplemented with L-cysteine and L-valine. The culture medium may include minerals such as magnesium (e.g., magnesium sulfate), and phosphate (e.g., potassium dihydrogenphosphate, disodium hydrogenphosphate). In certain embodiments, the culture medium includes glucose, plant peptone (polypeptone NS) or corn steep liquor (CSL), magnesium sulfate, and water. In certain embodiments, the culture medium includes glucose, polypeptone (polypeptone NS), magnesium sulfate, an antifoaming agent, and water. In certain embodiments, the culture medium includes glucose (0.45-1.0%), plant peptone (polypeptone NS) or CSL (0.9-4.0%), magnesium sulfate (0.0054-0.010%), an antifoaming agent (0.09%-0.11%), and water (balance). In certain embodiments, the culture medium includes glucose, oxidized starch (e.g., Pinedex #100) or maltodextrin, soy peptone (e.g., Hinute-R), ammonium sulfate, magnesium sulfate, potassium dihydrogenphosphate, disodium hydrogen phosphate, anti-foaming agent (e.g., Adekanol LG-109), L-cysteine, L-valine, and water. In certain embodiments, the culture medium includes glucose (2-10%), oxidized starch (e.g., Pinedex #100) or maltodextrin (1-15%), soy peptone (e.g., Hinute-R) (1-6%), ammonium sulfate (0-0.5%), magnesium sulfate (0-2%), potassium dihydrogenphosphate (0.275-1.65%), disodium hydrogen phosphate (0.18-1.08%), anti-foaming agent (e.g., Adekanol LG-109) (0.2-0.66%), L-cysteine (0-30 mM), L-valine (0-15 mM), and water.

Burkholderia A396 (NRRL B-50319) Strain. The Burkholderia A396 strain set forth herein is a non-Burkholderia cepacia complex, non-Burkholderia plantari, non-Burkholderia gladioli, Burkholderia sp and non-pathogenic to vertebrates, such as birds, mammals and fish. This strain can be isolated from a soil sample using procedures known in the art and described by Lorch et al., 1995. The isolation, characteristics, and method of obtaining metabolites of Burkholderia A396 are known in the art and can be found in, for example, U.S. Pat. No. 8,822,193 or U.S. Pat. No. 9,433,218, both of which are incorporated in reference in their entirety.

Provided herein is a method and herbicidal composition for controlling weeds by applying an effective amount of a) plant micronutrients and b) a compound having the general formula (I)

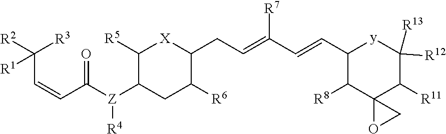

wherein X, Y and Z are each independently —O, —NR, or —S, wherein R is H or C₁-C₁₀ alkyl; R₁, R₂, R₃, R₄, R₅, R₆, R₇, R₈, R₁₁, R₁₂, and R₁₃ are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl; and b) at least one of a carrier, diluent, surfactant, adjuvant, and/or other herbicidal compounds or other pesticides to inhibit growth of said weeds.

In a particular aspect, the method above where the said compounds can have the structure:

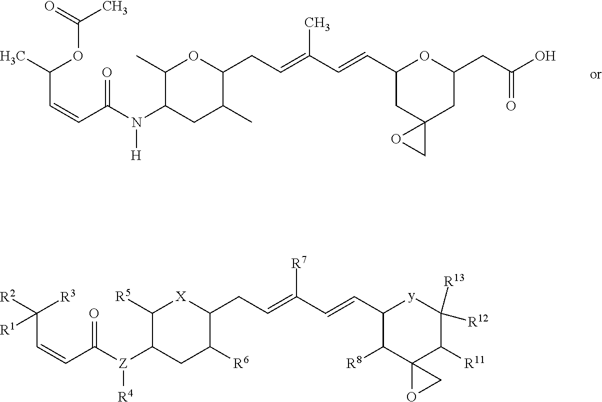

In another aspect, the method can include a first substance selected from the group consisting of one or more of the compounds set forth above; and b) plant micronutrients and c) optionally a second substance, wherein said second substance is a chemical or biological herbicide and/or pesticide and c) optionally at least one of a carrier, diluent, surfactant, or adjuvant.

Yet in another aspect, the weeds are controlled by inhibiting emergence and/or growth of monocotyledonous, sedge or dicotyledonous weeds comprising applying to said weed or soil an amount of (a) one or more of the compounds set forth above (b) plant micronutrients (c) optionally another substance, wherein said substance is a chemical or biological herbicide or (d) any combination set forth above in an amount effective to inhibit emergence or growth of monocotyledonous, sedge or dicotyledonous weeds.

In an aspect, said other herbicidal compounds include, but are not limited to: clove, cinnamon, lemongrass, citrus oils, orange peel oil, tentoxin, cornexistin, AAL-toxin, leptospermone, thaxtomin, sarmentine, momilactone B, sorgoleone, ascaulatoxin and ascaulatoxin aglycone. The chemical herbicide can include, but is not limited to, diflufenzopyr and salts thereof, dicamba and salts thereof, topramezone, tembotrione, S-metolachlor, atrazine, mesotrione, primisulfuron-methyl, 2,4-dichlorophenoxyacetic acid, nicosulfuron, thifensulfuron-methyl, asulam, metribuzin, diclofop-methyl, fluazifop, fenoxaprop-p-ethyl, asulam, oxyfluorfen, rimsulfuron, mecoprop, and quinclorac, thiobencarb, clomazone, cyhalofop, propanil, bensulfuron-methyl, penoxsulam, triclopyr, imazethapyr, halosulfuron-methyl, pendimethalin, bispyribac-sodium, carfentrazone ethyl, sodium bentazon/sodium acifluorfen, glyphosate, glufosinate, stearyl alcohol, and/or orthosulfamuron.

Yet in an aspect, the present disclosed herbicidal compounds exhibits synergistic effect with the aforementioned other herbicidal compound, as determined by COLBY's formula, where said formula has a ratio of greater than one.

In one aspect, the weeds include, but are not limited to: Amaranthus hypochondriacus, Amaranthus retroflexus, Amaranthus palmeri, Amaranthus rudis, Chenopodium album, Kochia scoparia, Abutilon theophrasti, Malva sylvestris, Stellaria media, Portulaca oleracea, Convolvulus arvensis, Ipomoea purpurea, Sinapsis arvensis, Raphanus raphanistrum, Medicago lupulina, Trifolium repens, Genista monspessulana, Epilobium angustifolium, Solanum nigrum, Setaria faberi, Bromus tectorum, Poa annua, Poa pratensis, Lolium multiflorum, Digitaria sanguinalis, Festuca arundinaceae, Echinochloa crus-galli, Plantago lanceolata, Helianthus annuus, Ambrosia artemisifolia, Bellis perennis, Taraxacum officinale, Lactuca serriola and/or Lactuca sativa.

In a related aspect, provided herein is a seed coated with aforementioned composition(s). The seed can be a genetically modified seed that is herbicide resistant.

Herbicidal Compounds. In a particular embodiment, the present invention relates to herbicidal compounds that have the structure:

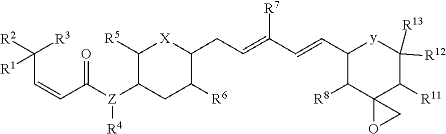

wherein X, Y and Z are each independently —O, —NR, or —S, wherein R is H or C₁-C₁₀ alkyl; R₁, 5 R₂, R₃, R₄, R₅, R₆, R₇, R₈, R₁₁, R₁₂, and R₁₃ are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl.

In a particular embodiment, the composition can have either of the following structures:

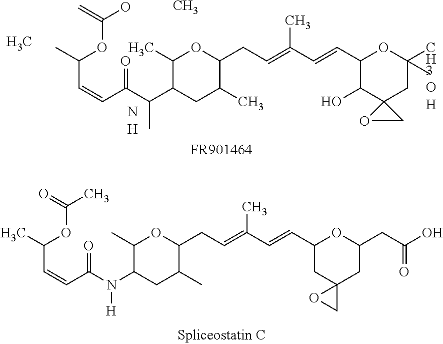

The compounds of the present disclosure can be chemically synthesized or derived from other sources such as from a biological material.

The compounds of the present disclosure can be applied before or after planting of the crops, before weeds emerge (pre-emergence application) or after weeds emerge (post-emergence application), and are particularly effective when applied post-emergence to the weeds.

The aforementioned compounds in combination with plant micronutrients according to the invention can be used as herbicides in unmodified form, as obtained in the synthesis, but they are generally formulated into herbicidal compositions in various ways using formulation adjuvants, such as carriers, solvents and surface-active substances. Therefore, the invention also relates to an herbicidal composition which comprises an herbicidally effective amount of a compound of formula (I) in addition to formulation adjuvants. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO Specifications for Plant Protection Products, 5th Edition, 1999. Such formulations can either be used directly or they are diluted prior to use. The dilutions can be made, for example, with water, liquid fertilizers, micronutrients, biological organisms, oil or solvents.

The formulations can be prepared, e.g. by mixing the active ingredient with the plant micronutrients and formulation adjuvants, in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof. The active ingredients can also be contained in very fine microcapsules consisting of a polymer. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art in this connection. Alternatively, very fine microcapsules can be formed in which the active ingredient is contained in the form of finely divided particles in a solid matrix of base substance, but the microcapsules are not themselves encapsulated.

The plant nutrients include iron and zinc; additional plant micronutrients include phosphate and potassium. Although the iron and zinc may be in any form and in any oxidation state known to the skilled artisan. For example, Zinc may be in the form of zinc picolinate, zinc acetate, zinc monomethionine, zinc glycerate, zinc citrate and zinc sulfate. Iron may be in the form of ferrous fumarate, ferrous gluconate, ferrous glutamate, ferric ammonium citrate, ferrous glycine, ferrous succinate and ferrous sulfate.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-20 dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol (PEG400), propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydro-furfuryl alcohol, hexanol, octanol, ethylene glycol, propylene glycol, glycerol, N-methyl-2-pyrrolidone and the like. Water is generally the carrier of choice for diluting the concentrates. Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances, as described, for example, in CFR 180.1001. (c) & (d).

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecyl-benzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in “McCutcheon's Detergents and Emulsifiers Annual” MC Publishing Corp., Ridgewood N.J., 1981. Formulation inerts can include sodium lauryl sulfate and ammonium sulfate. Organosilicone surfactants and methylated seed oils can also be used in the formulation.

Further adjuvants that can usually be used in pesticidal formulations include crystallization inhibitors, viscosity modifiers, suspending agents, dyes, anti-oxidants, foaming agents, light absorbers, mixing auxiliaries, antifoams, complexing agents, neutralizing or pH-modifying substances and buffers, corrosion inhibitors, fragrances, wetting agents, take-up enhancers, micronutrients, plasticizers, glidants, lubricants, dispersants, thickeners, antifreezes, microbicides, and also liquid and solid fertilizers.

The compositions according to the invention can additionally include an additive comprising an oil of vegetable or animal origin, a mineral oil, alkyl esters of such oils or mixtures of such oils and oil derivatives. The amount of oil additive in the composition according to the invention is generally from 0.01 to 10%, based on the spray mixture. For example, the oil additive can be added to the spray tank in the desired concentration after the spray mixture has been prepared. Preferred oil additives comprise mineral oils or an oil of vegetable origin, for example rapeseed oil, olive oil or sunflower oil, ⁻ of vegetable origin, for example the methyl derivatives, or an oil of animal origin, such as fish oil or beef tallow. A preferred additive contains, for example, as active components essentially 80% by weight alkylesters of fish oils and 15% by weight methylated rapeseed oil, and also 5% by weight of customary emulsifiers and pH modifiers. Especially preferred oil additives comprise alkyl esters of C8-C22 fatty acids, especially the methyl derivatives of C12-C18 fatty acids, for example the methyl esters of lauric acid, palmitic acid and oleic acid, being of importance. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Cognis GmbH). Those and other oil derivatives are also known from the Compendium of Herbicide Adjuvants, 5th Edition, Southern Illinois University, 2000.

The application and action of the oil additives can be further improved by combination with surface-active substances, such as non-ionic, anionic or cationic surfactants. Examples of suitable anionic, non-ionic and cationic surfactants are listed on pages 7 and 8 of WO 97/34485. Preferred surface-active substances are anionic surfactants of the dodecylbenzylsulfonate type, especially the calcium salts thereof, and also non-ionic surfactants of the fatty alcohol ethoxylate type. Special preference is given to ethoxylated C12-C22 fatty alcohols having a degree of ethoxylation of from 5 to 40. Examples of commercially available surfactants are the Genapol types (Clariant AG). Also preferred are silicone surfactants, especially polyalkyl-oxide-modified heptamethyltriloxanes which are commercially available e.g. as Silwet L-77®, and also perfluorinated surfactants. The concentration of the surface-active substances in relation to the total additive is generally from about 0.5% to about 30% by weight. Examples of oil additives consisting of mixtures of oil or mineral oils or derivatives thereof with surfactants are Edenor ME SU®, Turbocharge® (Syngenta AG, CH) or ActipronC (BP Oil UK Limited, GB).

If desired, it is also possible for the mentioned surface-active substances to be used in the formulations on their own, that is to say, without oil additives.

Furthermore, the addition of an organic solvent to the oil additive/surfactant mixture may contribute to an additional enhancement of action. Suitable solvents are, for example, Solvesso® (ESSO) or Aromatic Solvent® (Exxon Corporation). The concentration of such solvents can be from 10 to 80% by weight of the total weight. Oil additives that are present in admixture with solvents are described, for example, in U.S. Pat. No. 4,834,908. A commercially available oil additive disclosed therein is known by the name MERGE® (BASF Corporation). A further oil additive that is preferred according to the invention is SCORE® (Syngenta Crop Protection Canada).

In addition to the oil additives listed above, for the purpose of enhancing the action of the compositions according to the invention it is also possible for formulations of alkylpyrrolidones (e.g. AGRIMAX®) to be added to the spray mixture. Formulations of synthetic lattices, e.g. polyacrylamide, polyvinyl compounds or poly-1-p-menthene (e.g. Bond®, Courier® or EMERALD®) may also be used. It is also possible for solutions that contain propionic acid, for example EUROGKEM PEN-E-TRATE®, to be added to the spray mixture as action-enhancing agent.

The herbicidal compositions generally comprise from 0.1 to 99% by weight, especially from 0.1 to 95% by weight, compounds of formula (I) (e.g., spliceostatin C) and from 1 to 99.9% by weight of plant micronutrients and from 1 to 99.9% by weight of a formulation adjuvant which preferably includes from 0 to 25% by weight of a surface-active substance. Whereas commercial products will preferably be formulated as concentrates, the end user will normally employ dilute formulations.

In another aspect, any of the above compounds can be from either natural materials or compounds obtained or isolated from commercial sources or by chemical synthesis, for example, see U.S. patent application publication number U.S. 2008/0096879 A1, the content is hereby incorporated in reference in its entirety. Natural sources include, but are not limited to, microorganisms, alga, and sponges. In a more particular embodiment, microorganisms which include species such as Burkholderia sp. More specific embodiment include Burkholderia sp. A396 (NRRL B-50319).

Compounds of this disclosure can exist as one or more stereoisomers. The various stereoisomers include enantiomers, diastereomers, atropisomers and geometric isomers. Stereoisomers are isomers of identical constitution but differing in the arrangement of their atoms in space and include enantiomers, diastereomers, cis-trans isomers (also known as geometric isomers) and atropisomers. Atropisomers result from restricted rotation about single bonds where the rotational barrier is high enough to permit isolation of the isomeric species. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Compounds of this disclosure may be present as a mixture of stereoisomers, individual stereoisomers or as an optically active form.

The above compound(s) can be used as an herbicide. The method of the treatment of the plants and plant parts with the compositions set forth above can be carried out directly or by allowing the said compositions to act on their surroundings, habitat or storage space by, for example, immersion, drenching, chemigation, spraying, evaporation, fogging, scattering, painting on, injecting, and/or seed coating.

The compositions can be applied using methods known in the art. Specifically, the disclosed compositions can be applied to plants or plant parts. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being cotyledons, leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Compounds of this disclosure are generally useful as an herbicidal active ingredient in a composition, i.e. formulation, with at least one additional component selected from the group consisting of surfactants, solid diluents and liquid diluents, which serves as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions, oil-in-water emulsions, flowable concentrates and/or suspoemulsions) and the like, which optionally can be thickened into gels. The general types of aqueous liquid compositions are soluble concentrate, suspension concentrate, capsule suspension, concentrated emulsion, microemulsion, oil-in-water emulsion, flowable concentrate and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water, but occasionally another suitable medium like an aromatic or paraffinic hydrocarbon or vegetable oil. Spray volumes can range from about from about one to several thousand liters per hectare, but more typically are in the range from about ten to several hundred liters per hectare. Sprayable formulations can be tank mixed with water or another suitable medium for foliar or ground treatment by aerial or ground application, or for application to the growing medium of the plant. Liquid and dry formulations can be metered directly into drip irrigation systems or metered into the furrow during planting.

The formulations will typically contain effective amounts of active ingredient, effective amounts of plant micronutrients, diluent and surfactant within the following approximate ranges which add up to 100 percent by weight.

The substances set forth above used in the compositions and methods disclosed herein can be formulated in any manner. Non-limiting formulation examples include but are not limited to emulsifiable concentrates (EC), wettable powders (WP), soluble liquids (SL), aerosols, ultra-low volume concentrate solutions (ULV), soluble powders (SP), microencapsulation, water dispersed granules, flowables (FL), microemulsions (ME), nano-emulsions (NE), and seed treatments, etc. In any formulation described herein, percent of the active ingredient is within a range of 0.01% to 99.99% and include any and all incremental variations thereof.

The composition can additionally comprise a surfactant to be used for the purpose of emulsification, uptake, sticking, dispersion, wetting, spreading, integration, disintegration control, stabilization of active ingredients, and improvement of fluidity or rust inhibition. In a particular embodiment, the surfactant is a non-phytotoxic non-ionic surfactant which belongs to EPA Inerts List 4B. In another particular embodiment, the nonionic surfactant is polyoxyethylene (20) monolaurate. The concentration of surfactants can range between 0.1-35% of the total formulation, or range is 5-25%. The choice of dispersing and emulsifying agents, such as non-ionic, anionic, amphoteric and cationic dispersing and emulsifying agents, and the amount employed is determined by the nature of the composition and the ability of the agent to facilitate the dispersion of the compositions.

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, New Jersey.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), alkyl phosphates (e.g., triethyl phosphate), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters, alkyl and aryl benzoates and Û-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol, cresol and benzyl alcohol. Liquid diluents also include glycerol esters of saturated and unsaturated fatty acids (typically C6-C22), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present disclosure often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also, for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this disclosure can also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The composition as set forth above also comprises a stabilizing agent, which stabilizes a biological pesticide composition against physical separation and loss of activity due to exposure to sunlight. This stabilizing agent can be a benzoic acid salt or lignin sulfonate salt. Herbicidal compositions disclosed herein can be applied in liquid or solid form as pre-emergence or post-emergence formulations.

For pre-emergence dry formulations, the granule size of the carrier is typically 1-2 mm (diameter) but the granules can be either smaller or larger depending on the required ground coverage. Granules can contain porous or non-porous particles.

For post-emergence formulations, the formulation components used can contain smectite clays, attapulgite clays and similar swelling clays, thickeners such as xanthan gums, gum Arabic and other polysaccharide thickeners as well as dispersion stabilizers such as nonionic surfactants (for example polyoxyethylene (20) monolaurate). One of skill in the art appreciates the formulation type (dry or liquid) is not related to the timing of application. There may be dry formulations, and/or liquid formulations for both pre- and post-emergence formulations.

Furthermore, the compositions can be used in combination with seed-coating agents. Such seed coating agents can include, but are not limited to, ethylene glycol, carboxymethyl cellulose, methyl cellulose, polyethylene glycol, chitosan, carboxymethyl chitosan, peat moss, resins and waxes. The compositions can be applied using methods known in the art. Specifically, these compositions can be applied to and around plants or plant parts. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plants include all parts and organs of plants above and below the ground, such as shoot, leaf, flower and root, examples which may be mentioned being leaves, needles, stalks, stems, flowers, fruit bodies, fruits, seeds, roots, tubers and rhizomes. The plants include, but are not limited to, harvested material, and vegetative and generative propagation material, for example cuttings, tubers, rhizomes, offshoots and seeds.

A herbicidally effective amount of the compounds of this disclosure is determined by a number of factors. These factors include: formulation selected, method of application, amount and type of vegetation present, growing conditions, soil type, growth stage, etc. In general, a herbicidally effective amount of compounds of this disclosure is from about 0.005 to about 200 g/ha. In some embodiments, the range is from about 0.01 to about 1 kg/ha. One skilled in the art can easily determine the herbicidally effective amount necessary for the desired level of weed control.

Genetically modified plant cultivars which can be treated according to this disclosure include those that are resistant against one or more biotic stresses (pests such as nematodes, insects, mites, fungi, etc.) or abiotic stresses (drought, cold temperature, soil salinity, etc.), or that contain other desirable characteristics. Plants can be genetically modified to exhibit traits of, for example, herbicide tolerance, insect-resistance, modified oil profiles or drought tolerance. Useful genetically modified plants containing single gene transformation events or combinations of transformation events. Additional information for the genetic modifications can be obtained from publicly available databases maintained, for example, by the U.S. Department of Agriculture.

Treatment of genetically modified plants with compounds of this disclosure may result in super-additive or synergistic effects. For example, reduction in application rates, broadening of the activity spectrum, increased tolerance to biotic/abiotic stresses or enhanced storage stability may be greater than expected from just simple additive effects of the application of compounds of this disclosure on genetically modified plants.

Compounds of this disclosure can also be mixed with one or more other biologically active compounds or agents including herbicides, herbicide safeners, fungicides, insecticides, nematocides, bactericides, acaricides, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Mixtures of compounds of this disclosure with other herbicides can broaden the spectrum of activity against additional weed species, and suppress the proliferation of any resistant biotypes.

The composition can further comprise one or more additional herbicide. These include, but are not limited to, a bioherbicide and/or a chemical herbicide. The bioherbicide can be selected from the group consisting of clove, cinnamon, lemongrass, citrus oils, orange peel oil, tentoxin, cornexistin, AAL-toxin, leptospermone, thaxtomin, sarmentine, momilactone B, sorgoleone, pelargonic acid, caprylic acid, capric acid, ascaulatoxin and ascaulatoxin aglycone. The chemical herbicides can include, but are not limited to triazines, triazinones, ureas, amides, diphenyl ethers, triazolinones, bipyridyliums, clomazone, 4-HPPD inhibitors, PDS inhibitors, imidazolinones, sulfonylureas, pyrimidinyl (thio) benzoates, triazolopyrimidines, glycines, phosphinic acids, dinitrophenols, cyclohexanediones, aryloxyphenoxypropionates, asulam, thiocarbamates, dinitroanilines, carbamates, chloroacetamides, alkylazines, isoxaben, pyridine-carboxylic acids, benzoic acids, quinolinecarboxylic acids, phenoxycarboxylic acids and MSMA. The composition can further comprise one or more pesticides.

To widen the spectrum of action and to achieve synergistic effects, the compounds of the formula described herein can be mixed with an effective amount of plant nutrients (micronutrients and/or macronutrients) and optionally, a large number of representatives of other herbicidal or growth-regulating active ingredient groups and then applied concomitantly. Suitable components for mixtures are, for example, 1,2,4-thiadiazoles, 1,3,4-thiadiazoles, amides, aminophosphoric acid and its derivatives, aminotriazoles, anilides, (het)aryloxyalkanoic acids and their derivatives, benzoic acid and its derivatives, benzothiadiazinones, 2-aroyl-1,3-cyclohexanediones, 2-hetaroyl-1,3-cyclohexane-diones, hetaryl aryl ketones, benzylisoxazolidinones, meta-CF3-phenyl derivatives, carbamates, quinolinecarboxylic acid and its derivatives, chloroacetanilides, cyclohexenone oxime ether derivatives, diazines, dichloropropionic acid and its derivatives, dihydrobenzofurans, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and hetaryloxyphenoxypropionic esters, phenylacetic acid and its derivatives, 2-phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides, uracils, phenyl pyrazolines and isoxazolines and derivatives thereof.

In a particular embodiment, the compositions and herbicidal compounds are derived from the Burkholderia A396 (NRRL B-50319) strain.

The substances and compositions can also be used to modulate emergence in either a pre-emergent or post-emergent formulation of monocotyledonous, sedge or dicotyledonous weeds. In a particular embodiment, the weeds can be Amaranthus palmeri, Amaranthus rudis, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and/or Lactuca sativa.

Herbicidal Synergy. In one embodiment, the herbicidal composition of spliceostatin C and effective amounts of plant micronutrients can exhibit herbicidal synergy when applied with stearyl alcohol via rotation and/or tank mix.

Herbicidal Synergy. In one embodiment, the herbicidal composition of FR901464 and effective amounts of plant micronutrients can exhibit herbicidal synergy when applied with stearyl alcohol via rotation and/or tank mix. Herbicidal synergy can be measure by known method in the art. For example, using the Colby's formula, wherein when the ratio is greater than 1, it indicates synergy.

It is surprising and unexpected to have synergy between effective amounts of plant micronutrients and spliceostatin C to exhibit enhanced herbicidal activity. Since it is reported that iron is antagonistic to many herbicides (Zollinger, 2010) and iron containing compounds are known to degrade herbicides (i.e. Baloochi et al, 2018). In addition, zinc is often used to degrade conventional herbicides (Heena Khan & Pathak, 2020), which would be in direct contrast to our findings in our invention; zinc is also cited as a constituent component for controlled release of quinclorac (Mohd Sharifah et al, 2020).

This invention enhances the effectiveness of Burkholderia rinojensis a396 based herbicides (BRBH), potentially allowing for lower application rates, by adding selected plant micronutrients into the spray solution.

In one embodiment the present composition includes an effective amount of spliceostatin C and an effective amount of plant micronutrients formulated with commonly known inert chemical stabilizers and adjuvants. In addition, these herbicides are routinely applied in tank mix with commonly known adjuvants, particularly methylated seed oil and organosilicone surfactants, which are known to assist herbicides in penetrating leaf cuticles and flooding stomatal pores, respectively.

The present composition includes an effective amount of spliceostatin C and an effective amount of plant micronutrients to enhance plant phloem movement to: (a) increase uptake into leaves and/or (b) increase transport of active molecules to areas of higher growth in target plants, thereby lessening the chances of plant recovery after treatment. This is due to the operation of phloem, the role of nutrients in photosynthesis and the corresponding effects on overall plant metabolism (see Boundless, 2021; Jensen et al, 2013).

In addition, the present disclosure of an effective amount of spliceostatin C and an effective amount of plant micronutrients increases the metabolic activity of the plant in general. The plant micronutrients include iron, zinc, and/or molybdenum. Zinc may be in a chelated form. Zince may be in the form of zinc picolinate, zinc acetate, zinc monomethionine, zinc glycerate, zinc citrate and zinc sulfate and iron may be in the form of ferrous fumarate, ferrous gluconate, ferrous glutamate, ferric ammonium citrate, ferrous glycine, ferrous succinate and ferrous sulfate.

In the below data, all MBI-015 treatments included the standard adjuvant Dyne-Amic, a combination of methylated seed oil and organosilicone surfactant. Therefore, all increases in efficacy are above and beyond the effects of other adjuvants. The zinc and iron-based fertilizer increased control of Amaranthus tricolor with MBI-015 by 96% and 78% at the lower and higher rates, respectively.

The MBI-015 in the treatments is a formulation of inactivated Burkholderia rinojensis A396 whole cell broth for optimized spliceostatin C content and herbicidal use. Amaranthus tricolor plants were grown in a greenhouse to the 3-4 leaf stage in 2.5 cm square pots containing plant growth mix with slow-release fertilizer. Treatments were then applied using a research cabinet track sprayer fitted with an 8001 nozzle and at a carrier volume of 20 gal/A. Negative controls were sprayed with water. Pots were blocked and randomized by treatment after spray and placed in a growth room at 25° C. and 50% RH, and watered as necessary. Plants were evaluated 6 days after application for visual damage using a 0-5 scale, with 0 representing no control and complete health and 5 representing plant death or complete control. Scores of five replicates per treatment were average and multiplied by 20 to obtain a percent control. Data was subjected to ANOVA and means were separated using the Tukey method with 95% confidence intervals.

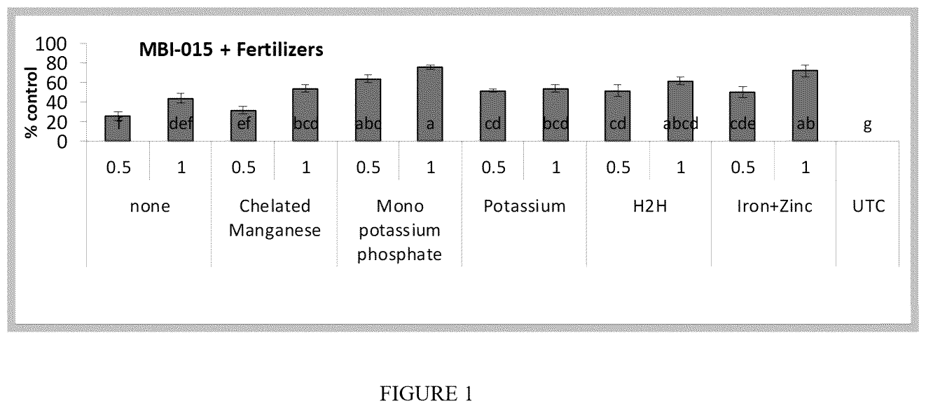

FIG. 1 is a table of phytotoxicity of MBI-015 and fertilizers at rates of 0.5 or 1 μg/mL. Different letters represent significantly different groups using Tukey HSD. Bars represent standard error.

| | | | | Visual Evaluation | | |
|---|---|---|---|---|---|---|
| | | | MBI-015 | AVG % | | |
| Treatment | Description | Additive | (μg/mL) | Control | SE | Tukey |
| 1 | MBI-015 | none | 0.5 | 26 | 4.0 | f |
| 2 | MBI-015 | | 1 | 44 | 5.1 | def |
| 3 | MBI-015 + Chelated Manganese at 1 lb | Chelated | 0.5 | 32 | 3.7 | ef |
| 4 | MBI-015 + Chelated Manganese at 1 lb | Manganese | 1 | 54 | 4.0 | bcd |
| 5 | MBI-015 + Monopotassium phosphate at 1 lb | Monopotassium | 0.5 | 64 | 4.0 | abc |
| 6 | MBI-015 + Monopotassium phosphate at 1 lb | phosphate | 1 | 76 | 2.5 | a |
| 7 | MBI-015 + Potassium at 0.5% v/v | Potassium | 0.5 | 52 | 2.0 | cd |
| 8 | MBI-015 + Potassium at 0.5% v/v | | 1 | 54 | 4.0 | bcd |
| 9 | MBI-015 + Phosphate at 0.5% v/v | H2H | 0.5 | 52 | 5.8 | cd |
| 10 | MBI-015 + Phosphate at 0.5% v/v | | 1 | 62 | 3.7 | abcd |
| 11 | MBI-015 + “Iron + Zinc” at 0.5% v/v | Iron + Zinc | 0.5 | 50 | 5.5 | cde |
| 12 | MBI-015 + “Iron + Zinc” at 0.5% v/v | | 1 | 72 | 5.8 | ab |
| 13 | UTC | none | | 0 | 0.0 | g |

H2H Organic 0-2-0 liquid fertilizer, obtained from California Safe Soil, was used for the H2H/Phosphate, which is a 2% phosphate formula. The advantage is that very low amounts of selected micronutrients can significantly enhance herbicidal activity of Burkholderia rinojensis (a396) based herbicides. Based on the above supporting data, the estimated amount of each tested plant nutrient needed to cover an acre is shown in the table below. Note that the estimated amounts of macronutrients (potassium and phosphorous) would significantly exceed the projected application rates of the Burkholderia rinojensis (a396) based herbicides themselves.

| Fertilizer | Mineral | g/Acre |
|---|---|---|
| Iron + Zinc | Zinc | 0.75708 |
| | Iron | 0.75708 |
| H2H | Phosphate | 7.5708 |
| Potassium | Potassium | 18.927 |
| Mono potassium | Potassium | 130.369 |
| Phosphate | Phosphorus | 103.114 |
| Chelated manganese | Manganese | 59.0522 |

The present invention shows that iron and/or zinc may enhance the activity of Burkholderia rinojensis (a396) based herbicides. These micronutrients, together with yucca extract, were the two main constituents in a fertilizer tested in the above assay.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Baloochi et al. 2018. 2,4-Dichlorophenoxyacetic acid herbicide photocatalytic degradation by zero-valent iron/titanium dioxide based on activated carbon. Environmental Nanotechnology, Monitoring & Management 10, p 212-22. https://www.sciencedirect.com/science/article/abs/pii/S2215153217302817
Boundless. 2021. 30.6D: Transportation of Photosynthates in the Phloem. https://bio.libretexts.org/Bookhelves/Inroductory_and_General_Biology/Book%3A_GeneralBiology_(Boundless)/30%3A_Plant_Form_and_Physiology/30.6%3A_Transport_of_Water_and_Solutes_in_Plants/30.6D%3A_Transportation_of_Photosynthates_in_the_Phloem
Engage Agro, 2021. Fiesta turf Weed killer. https://s3-us-west-1.amazonaws.com/agrian-cg-fs1-production/pdfs/Fiesta_CA_Label2.pdf
Heena Khan & Pathak, 2020. Zinc oxide based photocatalytic degradation of persistent pesticides: A comprehensive review. Environmental Nanotechnology, Monitoring & Management 13, https://www.sciencedirect.com/science/article/abs/pii/S2215153219302612
Jensen et al. 2013. Optimal concentration for sugar transport in plants. J R Soc Interface. 2013 Jun. 6; 10(83): 20130055. https://www.ncbi.nlm.nih.gov/pmc/articles/PMC3645415/
Mohd Sharifah. 2020. The influence of chitosan coating on the controlled release behaviour of zinc/aluminium-layered double hydroxide-quinclorac composite. Materials Chemistry and Physics Volume 251. https://www.sciencedirect.com/science/article/abs/pii/S025405842030451X
Sandy et al, 2021. Co-application effect of herbicides and micronutrients on weeds and nutrient uptake in flooded irrigated rice: Does it have a synergistic or an antagonistic effect?Crop Protection 149. https://www.sciencedirect.com/science/article/abs/pii/S0261219421002258
Zollinger, R. Proc. of the 2010 Wisconsin Crop Management Conference, Vol. 49, p. 45. https://extension.soils.wise.edu/wp-content/uploads/sites/68/2041/02/2010_wcmc_proc.pdf#page=47
Zollinger, 2010
Baloochi et al, 2018

1. A method for inhibiting emergence and/or growth of dicotyledonous weeds comprising:
applying to a plant, a plant part, or substrate used to grow the plant;
an effective amount of a fermented composition comprising whole cell broth collected from Burkholderia rinojensis A396 (NRRL Accession No. B-50319) fermentation, the whole cell broth further comprising an additional herbicidal compound and/or pesticidal compound; and
an effective amount iron and zinc, the effective amount of iron and zinc added to the whole cell broth in a concentration of 0.5% v/v.

2. (canceled)

3. (canceled)

4. (canceled)

5. The method of claim 1, wherein the dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Palmer amaranth, and Lactuca sativa.

6. (canceled)

7. The method of claim 1, wherein the additional herbicidal compound comprises at least one of: clove, cinnamon, lemongrass, citrus oils, orange peel oil, tentoxin, cornexistin, AAL-toxin, leptospermone, thaxtomin, sarmentine, momilactone B, sorgoleone, ascaulatoxin and ascaulatoxin aglycone.

8. The method of claim 1, wherein the additional herbicidal compound comprises at least one of: diflufenzopyr and salts thereof, dicamba and salts thereof, topramezone, tembotrione, S-metolachlor, atrazine, mesotrione, primisulfuron-methyl, 2,4-dichlorophenoxyacetic acid, nicosulfuron, thifensulfuron-methyl, asulam, metribuzin, diclofop-methyl, fluazifop, fenoxaprop-p-ethyl, asulam, oxyfluorfen, rimsulfuron, mecoprop, and quinclorac, thiobencarb, clomazone, cyhalofop, propanil, bensulfuron-methyl, penoxsulam, triclopyr, imazethapyr, halosulfuron-methyl, pendimethalin, bispyribac-sodium, carfentrazone ethyl, sodium bentazon/sodium acifluorfen, glyphosate, glufosinate, stearyl alcohol, and orthosulfamuron.

9. A method for inhibiting emergence or growth of monocotyledonous, sedge or dicotyledonous weeds comprising:
applying a composition of:
a) an effective amount of a compound having the general formula 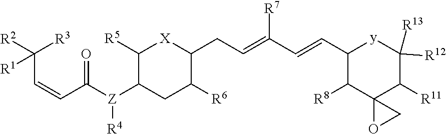
wherein X, Y and Z are each independently —O, —NR, or —S, wherein R is H or C₁-C₁₀ alkyl; R₁, R₂, R₃, R₄, R₅, R₆, R₇, R₈, R₁₁, R₁₂, and R₁₃ are each independently H, alkyl, substituted alkyl, alkyl carboxylate acid, alkenyl, substituted alkenyl, alkynyl, substituted alkynyl, aryl, substituted aryl, heteroaryl, substituted heteroaryl, heterocyclic, substituted heterocyclic, cycloalkyl, substituted cycloalkyl, alkoxy, substituted alkoxy, thioalkyl, substituted thioalkyl, hydroxy, halogen, amino, amido, carboxyl, —C(O)H, acyl, oxyacyl, carbamate, sulfonyl, sulfonamide, or sulfuryl;
b) an effective amount of one or more plant nutrients; and
c) at least one of a carrier, diluent, surfactant, adjuvant, wherein the composition inhibits emergence or growth of the monocotyledonous, sedge or dicotyledonous weeds.

10. The method of claim 9, wherein the compound is spliceostatin C or FR901464.

11. The method of claim 9, wherein the effective amount of one or more plant nutrients comprises an effective amount of one or more of: iron, zinc, boron, chlorine, copper, molybdenum, nickel, phosphate and potassium.

12. The method of claim 9, wherein the monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and Lactuca sativa.

13. The method of claim 9, wherein the composition further comprises an additional herbicidal compound or pesticide compound.

14. The method of claim 13, wherein said additional herbicidal compound comprises clove, cinnamon, lemongrass, citrus oils, orange peel oil, tentoxin, cornexistin, AAL-toxin, leptospermone, thaxtomin, sarmentine, momilactone B, sorgoleone, ascaulatoxin and ascaulatoxin aglycone.

15. The method of claim 13, wherein the additional herbicidal compound comprises diflufenzopyr and salts thereof, dicamba and salts thereof, topramezone, tembotrione, S-metolachlor, atrazine, mesotrione, primisulfuron-methyl, 2,4-dichlorophenoxyacetic acid, nicosulfuron, thifensulfuron-methyl, asulam, metribuzin, diclofop-methyl, fluazifop, fenoxaprop-p-ethyl, asulam, oxyfluorfen, rimsulfuron, mecoprop, and quinclorac, thiobencarb, clomazone, cyhalofop, propanil, bensulfuron-methyl, penoxsulam, triclopyr, imazethapyr, halosulfuron-methyl, pendimethalin, bispyribac-sodium, carfentrazone ethyl, sodium bentazon/sodium acifluorfen, glyphosate, glufosinate, stearyl alcohol, or orthosulfamuron.

16. The method of claim 13, wherein said compound is isolated from Burkholderia sp.

17. The method of claim 16, wherein said Burkholderia sp. is Burkholderia A396 (NRRL B-50319).

18. (canceled)

19. A synergistic herbicidal composition comprising:
(a) the compound FR901464 or spliceostatin C;
(b) an effective amount of one or more plant nutrients; and
(c) at least one of a carrier, diluent, surfactant, adjuvant, wherein the composition inhibiting emergence and/or growth of monocotyledonous, sedge or dicotyledonous weeds.

20. The synergistic herbicidal composition of claim 19, further comprising an amount of a fermented composition comprising whole cell broth collected from Burkholderia rinojensis A396 (NRRL Accession No. B-50319)

21. The synergistic herbicidal composition of claim 19, wherein said effective amount of one or more plant nutrients comprise iron, zinc, boron, chlorine, copper, molybdenum, nickel, phosphate and potassium

22. The synergistic herbicidal composition of claim 19, wherein said monocotyledonous, sedge or dicotyledonous weeds are selected from the group consisting of Amaranthus hypochondriacus, Chenopodium album, Abutilon theophrasti, Helianthus annuus, Ambrosia artemesifolia, Amaranthus retroflexus, Convolvulus arvensis, Brassica kaber, Taraxacum officinale, Solanum nigrum, Malva neglect, Setaria lutescens, Bromus tectorum, Poa annua, Poa pratensis, Palmer amaranth, Lolium perenne L. var. Pace, Festuca arundinaceae Schreb. var. Aztec II, Anthem II, LS1100, Echinochloa crus-galli, and Lactuca sativa.

23. The synergistic herbicidal composition of claim 19, wherein said composition further comprises an additional herbicidal compound and/or pesticidal compound.

24.-28. (canceled)
